(19) United States
(12) Patent Application Publication
(10) Pub. No.: US 2026/0113326 A1
(43) Pub. Date: Apr. 23, 2026

(54) SYSTEMS AND METHODS FOR GENERATING DYNAMIC DATA SECURITY LAYERS FOR DISPARATE ELECTRONIC ENVIRONMENTS

(71) Applicant: BANK OF AMERICA CORPORATION, CHARLOTTE, NC (US)

(72) Inventors: Ana Maxim, Arlington, VA (US); Marshall Adam Johnson, Summit, NJ (US); Manu Jacob Kurian, Dallas, TX (US); Emily Green, Charlotte, NC (US); Sandra Lynn Dube, Salt Lake City, UT (US)

(73) Assignee: BANK OF AMERICA CORPORATION, CHARLOTTE, NC (US)

(21) Appl. No.: 18/921,687

(22) Filed: Oct. 21, 2024

(51) Int. Cl. H04L 9/40

(52) U.S. Cl. CPC H04L 63/102; H04L 63/20

(57) ABSTRACT

Systems, computer program products, and methods are described herein for generating dynamic data security layers for disparate electronic environments. The present disclosure is configured to identify a potential recipient identifier; identify user account data associated with the potential recipient identifier; apply the user account data and the potential recipient identifier to an artificial intelligence (AI) engine; determine, by the AI engine, a data security layer for the potential recipient identifier and the user account data; and automatically generate, by the AI engine, a data security layer dataset from the user account data.

### TECHNOLOGICAL FIELD

Example embodiments of the present disclosure relate to generating dynamic data security layers for disparate electronic environments.

### BACKGROUND

In disparate electronic environments, users storing secure and non-public data have a harder time than ever protecting their data and making sure potential electronic recipients (such as websites, electronic entities, servers, and/or the like) will not misappropriate their data or use their data for more than the user originally intended. Thus, and as more and more electronic transmissions occur everyday for most of today's populace, it is more important than ever to protect secure electronic data between different electronic environments, such as between different websites, electronic entities, servers, protect from man-in-the-middle attacks, and/or the like. Therefore, a need exists for a system that can generate dynamic data security layers for disparate electronic environments in an accurate, efficient, and secure manner (which may include protecting across networks, websites, and across data types).

Applicant has identified a number of deficiencies and problems associated with generating dynamic data security layers for different electronic environments. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for generating dynamic data security layers for disparate electronic environments.

In one aspect, a system for generating dynamic data security layers for disparate electronic environments is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify a potential recipient identifier; identify user account data associated with the potential recipient identifier; apply the user account data and the potential recipient identifier to an artificial intelligence (AI) engine; determine, by the AI engine, a data security layer for the potential recipient identifier and the user account data; and automatically generate, by the AI engine, a data security layer dataset from the user account data.

In some embodiments, the potential recipient identifier comprises at least one of an internet protocol (IP) address, a hypertext transfer protocol secure (HTTPS) address, an electronic communication address, or a use-case identifier.

In some embodiments, executing the computer-readable code is further configured to cause the at least one processing device to: generate a digital user persona based on the data security layer dataset for the user account; and transmit the digital user persona to the potential recipient identifier.

In some embodiments, executing the computer-readable code is further configured to cause the at least one processing device to: determine a plurality of data security layers based on one or more potential recipient identifiers, wherein each data security layer may be specific to each potential recipient identifier; and generate a plurality of data security layer datasets with pieces of data from the user account data based on the plurality of data security layers.

In some embodiments, the potential recipient identifier is received from a user device associated with a user account of the user account data.

In some embodiments, executing the computer-readable code is further configured to cause the at least one processing device to: generate a training dataset comprising historical data security layers, historical data security layer datasets, and historical recipient identifiers; and apply the training dataset to the AI engine; and train the AI engine at least at a first instance by applying the training dataset to the AI engine. In some embodiments, the training dataset comprises historical data security levels associated with a user account, historical data security layer datasets associated with the user account, and historical recipient identifiers associated with the user account.

In some embodiments, executing the computer-readable code is further configured to cause the at least one processing device to: identify a use-case for the user account data at the potential recipient identifier; update the data security layer based on the use-case; and generate the data security layer dataset from the user account data based on the updated data security layer.

In some embodiments, the data security layer dataset is limited by a viability threshold time, and wherein, in an instance where the viability threshold time is met, the data security layer dataset is destroyed or denied access for the potential recipient identifier.

In some embodiments, executing the computer-readable code is further configured to cause the at least one processing device to: transmit, in response to the generated data security layer dataset by the AI engine, a data security layer approval interface component to a user device associated with the user account data; receive, from the user device, a user account response to the generated data security layer dataset, wherein the user account response comprises an approval or denial; and transmit the data security layer dataset to the potential recipient identifier based on the approval of the user account response. In some embodiments, executing the computer-readable code is further configured to cause the at least one processing device to: receive, based on the denial of user account response, an updated data security layer dataset from the user device, wherein the updated data security layer dataset comprises at least one addition or at least one deletion of user account data from the generated data security layer dataset; and transmit the updated data security layer dataset to the potential recipient identifier.

In some embodiments, the data security layer dataset is an imitation of the user account data.

In some embodiments, the data security layer dataset is an encrypted container or an encrypted distributed ledger entry.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating dynamic data security layers for disparate electronic environments, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for generating dynamic data security layers for disparate electronic environments, in accordance with an embodiment of the disclosure;

FIG. 4 illustrates generating and transmitting a digital user persona based on the data security layer dataset, in accordance with an embodiment of the disclosure;

FIG. 5 illustrates a process flow for generating a plurality of data security layer datasets based on a plurality of potential recipient identifiers, in accordance with an embodiment of the disclosure;

FIG. 6 illustrates a process flow for training the AI engine, in accordance with an embodiment of the disclosure;

FIG. 7 illustrates a process flow for generating the data security layer dataset based on an updated data security layer, in accordance with an embodiment of the disclosure; and

FIG. 8 illustrates a process flow for receiving a user account response for the generated data security layer dataset and, in some instances, updating the generated data security layer dataset based on the user account response, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In disparate electronic environments, users storing secure and non-public data have a harder time than ever protecting their data and making sure potential electronic recipients (such as websites, electronic entities, servers, and/or the like) will not misappropriate their data or use their data for more than the user originally intended. Thus, and as more and more electronic transmissions occur everyday for most of today's populace, it is more important than ever to protect secure electronic data between different electronic environments, such as between different websites, electronic entities, servers, protect from man-in-the-middle attacks, and/or the like. Therefore, a need exists for a system that can generate dynamic data security layers for disparate electronic environments in an accurate, efficient, and secure manner (which may include protecting across networks, websites, and across data types).

Accordingly, the present disclosure provides for the identification of a potential recipient identifier; the identification of user account data associated with the potential recipient identifier; and the application of the user account data and the potential recipient identifier to an artificial intelligence (AI) engine. Further, and based on applying the user account data and the potential recipient identifier to the AI engine, the AI engine may determine a data security layer for the potential recipient identifier and the user account data; and automatically generate, by the AI engine, a data security layer dataset from the user account data.

In other words, the disclosure comprises a system comprising a trained AI engine which has been trained and configured to determine data security layers for a potential recipient (e.g., a website, an electronic entity, a network, a server environment, and/or the like) that a user will likely send their secure data to. Further, and in some embodiments, the system may additionally determine customized data security layers for specific use-cases for each potential recipient, such that the data security layers may comprise increased data security in an instance where data of a greater non-public nature (e.g., a social security number, an address, and/or the like) is intended to be shared, or a lower data security layer in an instance where the user doesn't wish for the shared data to be as protected (e.g., data that may be readily available outside of the secure user account). Further, and based on the data security layer determined by the AI engine, the AI engine may generate a data security layer dataset from secure user account data (e.g., which may be a copy of a portion of the user account data, an imitation of the user account data, and/or the like), which may be shared with the potential recipient in a secure manner. By limiting the data in the data security layer dataset to only the data necessary for the potential recipient, the system may also limit data storage requirements, limit network transmission size, and improve network processing speeds, by allowing for only small amounts of data for each data security layer dataset to be stored and transmitted.

Additionally, and in some embodiments, the disclosure comprises a system using a digital wallet or digital persona of the user, whereby the digital wallet or the digital persona is split into multiple levels of what data can be published regarding the user. For example, the disclosure may comprise a base layer that can be openly shared (a public layer), another layer that may comprise more secure data which may need additional or extreme data privacy mechanisms to protect the data, and/or the like. In this manner, the user can choose which level they want to share in each digital environment, depending on the level of security needed, the action the user will take (e.g., buying personal or family items may be used with the higher level digital wallet as a user may want to protect their privacy more, or buying a normal product may use the lower level digital wallet as the user may not care what data or persona is shown for this action). Additionally, and in some embodiments, the disclosure may further tokenize the data within the digital wallet so the data itself isn't moving for each of these actions, but instead a representation of the data is moving.

What is more, the present disclosure provides a technical solution to a technical problem. As described herein, the technical problem includes the sharing of secure data across networks and across disparate electronic environments, where such data may be intervened by man-in-the-middle attacks, misappropriated, or used beyond their intended purpose. The technical solution presented herein allows for the dynamic and customized generation of secure data packets that are shared across different electronic environments. In particular, the disclosure is an improvement over existing solutions to data security, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

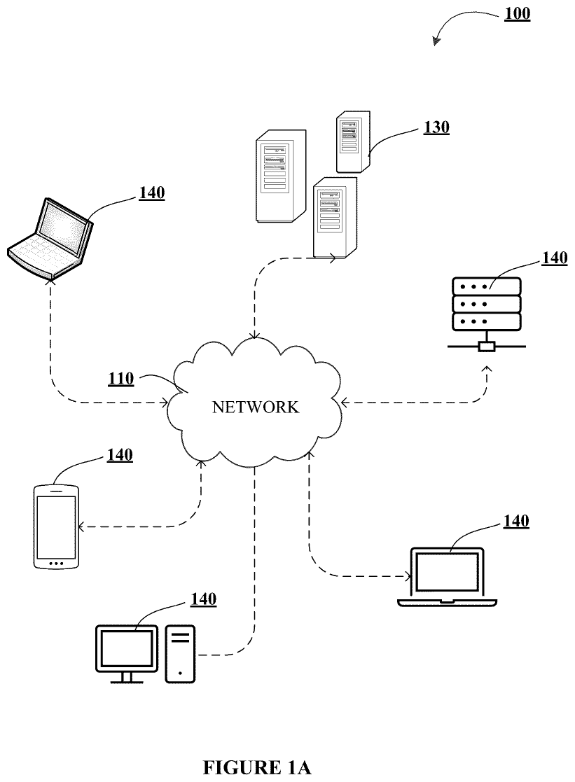

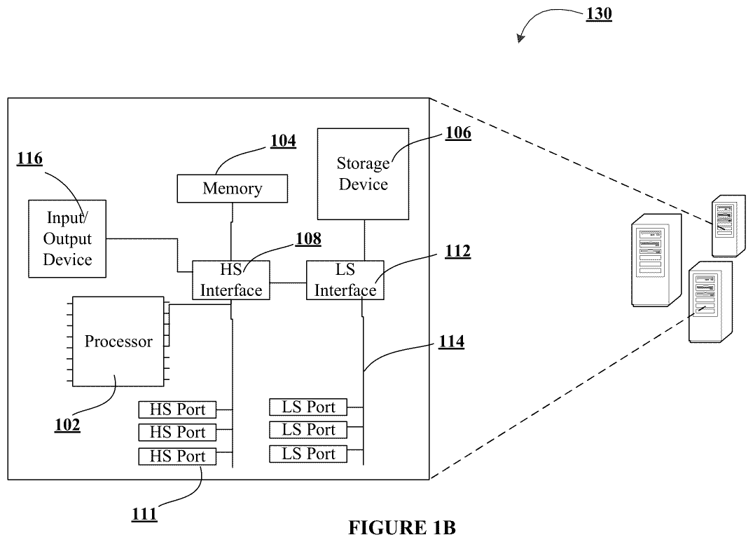

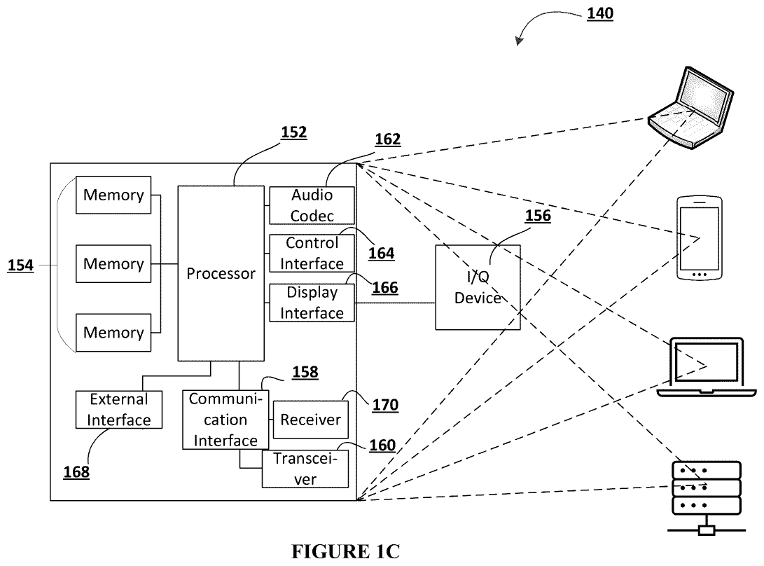

FIGS. 1A-1C illustrate technical components of an exemplary distributed computing environment for generating dynamic data security layers for disparate electronic environments 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

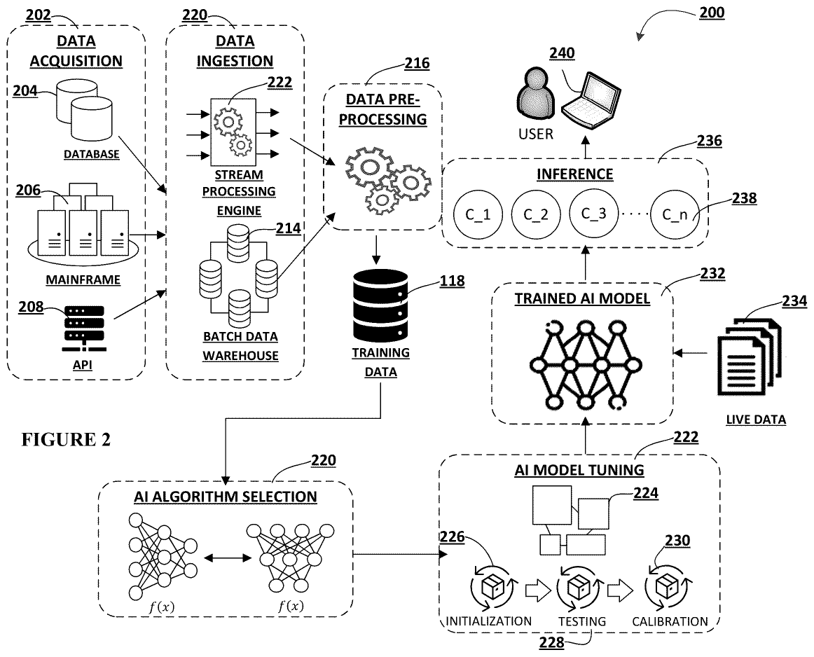

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

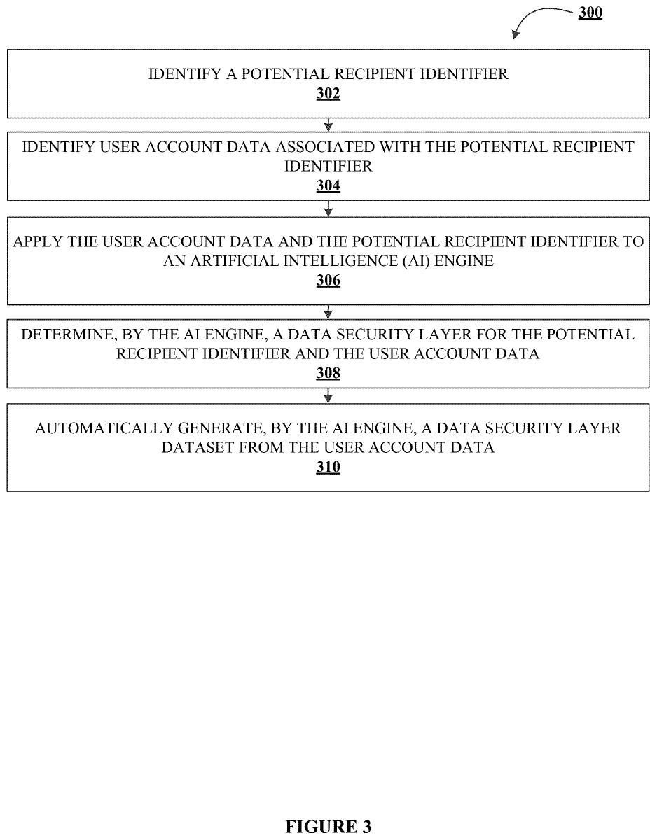

FIG. 3 illustrates a process flow 300 for generating dynamic data security layers for disparate electronic environments, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process flow 300. Additionally, and in some embodiments, an AI engine (e.g., the AI subsystem 200 described herein with respect to FIG. 2) may be generated and trained to perform the steps of process flow 300.

As shown in block 302, the process flow 300 may include the step of identifying a potential recipient identifier. For instance, the system may identify a potential recipient identifier based on identifying potential recipients a user within an associated network may share their user account data and/or their secure data. For example, such a potential recipient identifier may comprise a website identifier (e.g., a hypertext transfer protocol secure (HTTPS) address), an entity identifier (e.g., a company name/identifier), an internet protocol (IP) address, an electronic communication address (e.g., an email address, an instant messaging address/identifier, and/or the like), and/or the like. In this manner, the potential recipient identifier may uniquely identify an entity a user associated with the user account may intend to share their secure data or information with. Such secure data or information may comprise a user's social security number, home address, work address, account information (e.g., bank account information, user account information for another entity, and/or for the potential recipient system, and/or the like), phone number, and other such non-public data or information. Thus, and in some embodiments, the potential recipient identifier comprises at least one of an internet protocol (IP) address, a hypertext transfer protocol secure (HTTPS) address, an electronic communication address, or a use-case identifier (e.g., such as a specific use-case that the recipient entity will use the user account data for).

In some embodiments, the user may wish to share specific portions of their user data with a specified entity (e.g., an entity, website, email address, and/or the like, that the user specifies to receive their specified portion of their user account data). Thus, and in some embodiments, the potential recipient identifier is received from a user device associated with a user account of the user account data. For example, and where a recipient entity requests a home address from the user to send marketing materials, then the user may indicate the recipient entity as the potential recipient entity in the process described herein. In some embodiments, and based on this identified potential recipient identifier, the system may follow the process(es) described herein to generate a data security layer and data security layer dataset (or packet of user account data) for the potential recipient identifier, such that the rest of the user account data is not shown to the potential recipient.

In some embodiments, the system may automatically identify the potential recipient identifier based on analyzing each recipient that has received historical user account data for the specific user and/or for each of the user accounts within a network (e.g., the network running and interacting with the system). In some embodiments, the system may analyze all the historical recipient identifiers interacted by a user account or a plurality of user accounts within the network, and based on the historical recipient identifiers, may generate a list of potential recipient identifiers the system must analyze each potential recipient identifier fully to determine each data security layer for each potential recipient identifier, and further, generate each data security layer dataset for each data security layer. Thus, and in such an instance, the system may generate a list of all the historical recipient identifiers that need to be analyzed to determine the data security layers, and the system may automatically and systematically move down the list until all the historical recipient identifiers have been analyzed, their data security layers have been generated, and, in some instances, their data security layer datasets have been generated.

As shown in block 304, the process flow 300 may include the step of identifying user account data associated with the potential recipient identifier. For instance, the system may identify user account data associated with a user account that is currently attempting to transmit user data to the potential recipient or may, sometime in the future, attempt to transmit user data to the potential recipient. Thus, and in some embodiments, the system may identify user account data based on identifying a user account identifier that is associated with a request to transmit their secure data or information, at a current instance, to the potential recipient identifier identified in block 302. In some embodiments, the system may identify user account data based on identifying a user account identifier associated with historical data transmissions to historical recipient identifiers, whereby the system may determine that a user account is likely to transmit data at a future time to the potential recipient identifier (such as potential recipient identifier that has previously or historically received data from the user).

As shown in block 306, the process flow 300 may include the step of applying the user account data and the potential recipient identifier to an artificial intelligence (AI) engine. For instance, the system may apply the user account data identified in block 304 and the potential recipient identifier identified in block 302 to an AI engine that is trained and configured to determine an appropriate data security layer to cluster some or all of the user account data. For example, such a data security layer may indicate the level of data security needed for each potential recipient identifier and/or for each use-case of each potential recipient identifier (e.g., one potential recipient identifier may have a plurality of use-cases, and each use-case may have its own data security layer, such that each data security layer is specific to protect some of the user account data and/or allow access to a specified portion of the user account data). Thus, and as described herein, the data security layer may identify which types of data need to remain hidden (or outside of the associated data security layer dataset generated from the user account data) and which types of data can be included in the data security layer dataset for the potential recipient identifier and, in some embodiments, the use-case.

Additionally, and in some embodiments, the system may comprise a trained AI engine that is trained and configured to analyze both the potential recipient identifier (and in some instances, the historical actions, historical use-cases, historical user account data accessed by the potential recipient identifier, and historical uses of the accessed user account data by the potential recipient), and the user account data accessible by the system and by the user associated with the user account that is available for the user to select for sharing. Based on this analysis by the AI engine, the AI engine may determine the appropriate data security layer that should be used for the potential receipt identifier, the use-case of the potential recipient identifier, and/or the user account data available for sharing to the potential recipient.

Thus, and in some embodiments, the AI engine may analyze the use-case for the potential recipient account (i.e., the specific use the potential recipient will use the user account data for, such as for marketing, sending mail, signing up for an account, signing up for a credit card, and/or the like). Therefore, and based on this use-case, the AI engine may determine whether a higher data security layer (e.g., where less user account data will be available for the potential recipient) or a lower data security layer (e.g., where more user account data will be available for the potential recipient) is appropriate for the use-case and the potential recipient identifier.

As shown in block 308, the process flow 300 may include the step of determining, by the AI engine, a data security layer for the potential recipient identifier and the user account data. For instance, the system may determine the appropriate data security layer for the potential recipient identifier (or a plurality of data security layers for the potential recipient identifier, such as for a plurality of use-cases) and the user account data (e.g., where the user account data comprises a lot of secure and non-public information, the system may determine a higher data security layer is necessary to protect the secure and non-public information in most use-cases).

In some embodiments, the AI engine may determine the data security layer based on past or historical data security layers determined for the same potential recipient identifier, historical data security layers for similar potential recipient identifiers (e.g., within the same business model or same industry as the current potential recipient identifier), past or historical use cases by the potential recipient identifier, historical access to past user account data (e.g., which may be associated with the same user account of the current process, and/or may be associated with other similar user accounts with similar user account data types and/or within the same network), and/or the like. Thus, and in some embodiments, the AI engine may be trained to analyze what the potential recipient identifier has done in the past with user account data, which may have been associated with a specific use-case or not associated with a specific use-case, and what user account data was available to the potential recipient identifier in the historical instances the potential recipient identifier used the user data (e.g., did the potential recipient identifier use all the data available to it at the time), and/or the like. Based on this analysis, the AI engine may determine what data must be protected in the user account data and which data in the user account data may be accessible to the potential recipient. Further, and in some such embodiments, the AI engine may further refine this determination of the data security layer to be use-case-specific, such that some data made available from the user account data may be blocked from accessibility for particular use-cases, and/or some data not previously made available may now be accessible to the potential recipient for a particular use-case(s).

As shown in block 310, the process flow 300 may include the step of automatically generating, by the AI engine, a data security layer dataset from the user account data. For example, the system may automatically generate the data security layer dataset from the user account data (e.g., from a copy of the user account data and/or an imitation of the user account data) based on the data security layer determined in block 308, whereby the data security layer dataset may comprise the data available and accessible to the potential recipient. In some embodiments, and where a potential recipient is associated with a plurality of use-cases, then the system may generate a of data security layer dataset for each use-case, where each data security layer dataset may comprise at least a portion of the user account data (or an imitation of the user account data), where each data security layer dataset may comprise its own specific combination of user account data (e.g., pieces of data collected or imitated from the user account data) for the purpose of the identified use-case. In this manner, each data security layer dataset may limit its accessible data and current data storage to only the user account data (or imitated user account data) necessary for each potential recipient identifier and/or for each use-case of the potential recipient identifier, which further improves computer functionality in limiting data storage to only the data necessary for each potential recipient identifier and/or use case.

Thus, and as described briefly above and in some embodiments, the data security layer dataset may be an imitation of the user account data. Thus, and in some embodiments, the system may generate an imitation or a fake rendering of the real user account data in order to protect the underlying real user account data. By way of non-limiting example, and where the potential recipient identifier is associated with an e-commerce website, and the data security layer indicates that a credit card number, and an associated user home address may be needed for to complete a use-case of purchasing an item, then the system may generate a data security layer dataset comprising a virtual credit card which is associated with a credit card number in the real user account data, and the real user home address associated with the credit card. Thus, and as understood by a person of skill in the art, the example provided herein regarding a virtual credit card is meant to show an exemplary use-case and exemplary imitation of the user account data and is not intended to be limiting in any way. Such an imitation of the user account data may be used to imitate any of the user account data stored and/or associated with the user account and other associated user accounts of the user. In some embodiments, the imitation of the user account data for the data security layer dataset may only be used and generated for a highest data security layer, which may in turn conserve computing resources by only requiring an extra process of generating imitation user account data in particular, high security instances.

In some embodiments, the data security layer dataset is an encrypted container or an encrypted distributed ledger entry. Thus, and in some such embodiments, the system may generate the data security layer dataset and then store the data security layer dataset in a container or in a distributed ledger as a ledger entry, such that the stored data security layer dataset cannot be accessed without the proper decryption key.

Additionally, and in some embodiments, the data security layer dataset is limited by a viability threshold time, and wherein, in an instance where the viability threshold time is met, the data security layer dataset is destroyed or denied access for the potential recipient identifier. Thus, and for instance, the system may determine a viability threshold time for the data security layer dataset to be available to the potential recipient, and in an instance where the viability threshold time has been met or is surpassed by the current time, the system may automatically destroy the data security layer dataset (such as where the data security layer dataset is generated with a copy of the user account data), and/or block access to the data security layer dataset by the potential recipient. Thus, and in this manner, the potential recipient will be limited from accessing the data security layer dataset after a specified time (e.g., viability threshold time) that the potential recipient has to use the data of the data security layer dataset. In some embodiments, the AI engine may be trained and configured to determine the viability threshold time. Such a training of the AI engine to determine the viability threshold time may be based on historical viability threshold times, historical times the potential recipient or similar potential recipients have used similar data and/or for similar use-cases, and/or based on the data security layer (i.e., the level of data security determined by the AI engine, where a shorter viability threshold time may be used for a higher data security layer, or a longer viability threshold time may be used for a lower data security layer), and/or the like.

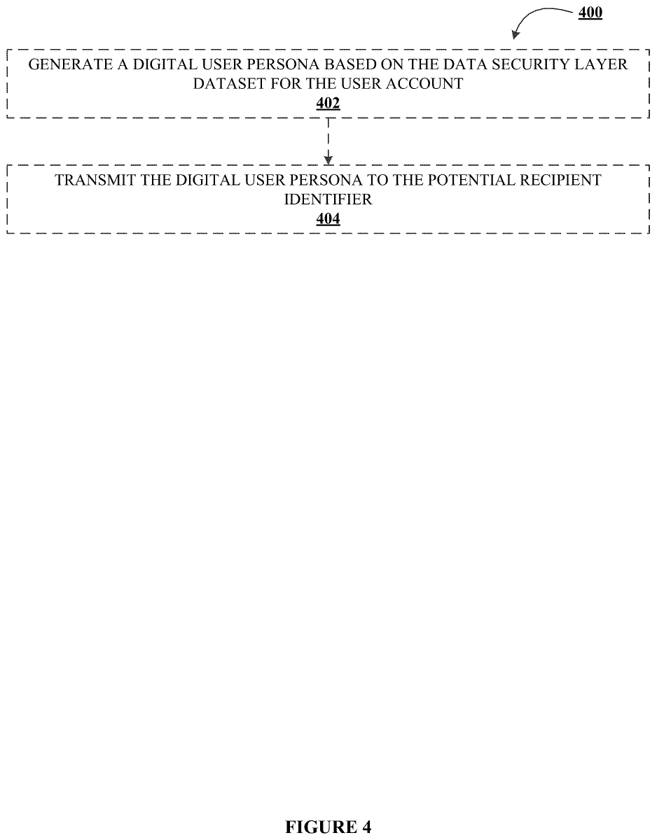

FIG. 4 illustrates a process flow 400 for generating and transmitting a digital user persona based on the data security layer dataset, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process flow 400. Additionally, and in some embodiments, an AI engine (e.g., the AI subsystem 200 described herein with respect to FIG. 2) may be generated and trained to perform the steps of process flow 400.

In some embodiments, and as shown in block 402, the process flow 400 may include the step of generating a digital user persona based on the data security layer dataset for the user account. For instance, and in some embodiments, the system may generate a digital user persona, based on the data security layer dataset, whereby the digital user persona may comprise some or all the data security layer dataset in a particular format. For instance, and in some embodiments, the digital user persona may comprise a digital wallet, a digital personification of the user (e.g., within a metaverse environment), and/or the like. Thus, and in some such embodiments, the digital user persona may be used by the user of the user account to showcase the data of the data security layer dataset. In some embodiments, and in an instance where the user account is associated with a plurality of data security layers, then the system may generate a plurality of digital user personas (each with their own data and/or formatting) and/or the system may generate each digital user persona associated with each data security layer from high to low with more data shown (e.g., as the data security layer moves from high to low, the virtual persona may have more features or data shown in the digital rendering, thus showing more data to the potential recipient).

Thus, and by way of non-limiting example, the disclosure provided herein may comprises a system using a digital wallet or digital persona of the user, whereby the digital wallet or the digital persona is split into multiple levels of what data can be published regarding the user. For example, the disclosure may comprise a base layer that can be openly shared (a public layer, or lowest layer of the data security layers), another layer that may comprise more secure data which may need additional or extreme data privacy mechanism to protect the data, a highest layer that comprises the most secure data (e.g., the highest layer of the data security layers), and/or the like. In this manner, the user can choose which level they want to share in each digital environment, depending on the level of security needed, the action the user will take (e.g., buying personal or family items may be used with the higher level digital wallet as a user may want to protect their privacy more, or buying a normal consumer product may use the lower level digital wallet as the user may not care what data or persona is shown for this action). Additionally, and in some embodiments, the disclosure may further tokenize the data within the digital wallet so the data itself isn't moving for each of these actions, but instead a representation of the data is moving (e.g., a copy and/or an imitation).

In some embodiments, and as shown in block 404, the process flow 400 may include the step of transmitting the digital user persona to the potential recipient identifier. For instance, the system may transmit the digital user persona to the potential recipient associated with the potential recipient identifier (e.g., a user device associated with the potential recipient identifier, a server associated with the potential recipient identifier, and/or the like), such that the potential recipient has access to the data within the data security layer dataset. In some embodiments, and where the digital user persona is generated within a metaverse environment, the system may transmit the digital user persona in the metaverse environment to the potential recipient within the metaverse environment (e.g., a digital representation within the metaverse of a brick and mortar location, and/or the like).

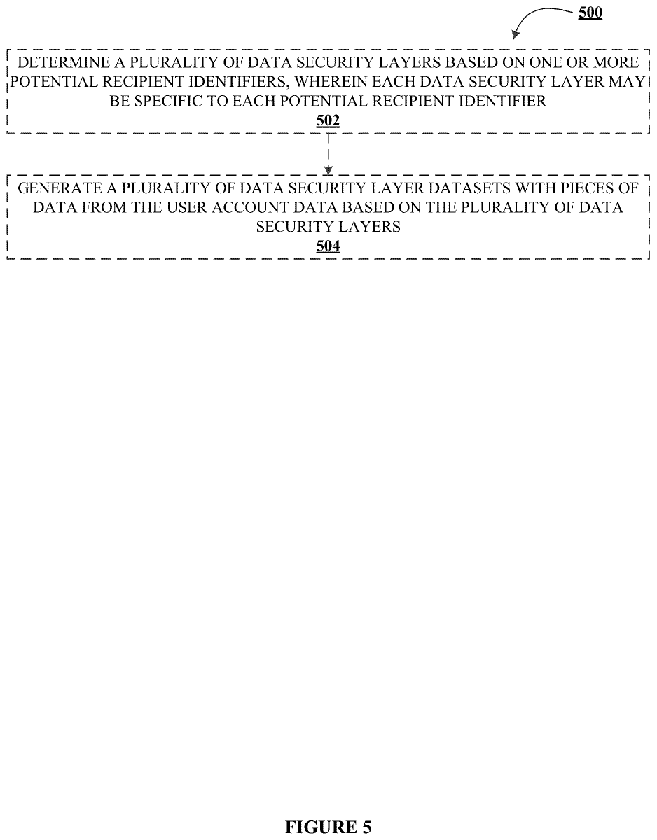

FIG. 5 illustrates a process flow 500 for generating a plurality of data security layer datasets based on a plurality of potential recipient identifiers, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process flow 500. Additionally, and in some embodiments, an AI engine (e.g., the AI subsystem 200 described herein with respect to FIG. 2) may be generated and trained to perform the steps of process flow 500.

In some embodiments, and as shown in block 502, the process flow 500 may include the step of determining a plurality of data security layers based on one or more potential recipient identifiers, wherein each data security layer may be specific to each potential recipient identifier. For instance, and in some embodiments, the system may determine a plurality of data security layers for one potential recipient identifier (such as where one potential recipient is associated with a plurality of use-cases and each use-case needs its own data security layer) or more potential security layers (such as where each potential recipient is associated with a plurality of use-cases, a plurality of potential recipients each have their own plurality of use-cases, and/or each potential recipient is only associated with one data security layer). Thus, and in some such embodiments, the system dynamically determines the data security layer(s) needed for each potential recipient and/or plurality of potential recipients, where each potential recipient may need its own data security layer and, thus, its own custom data security layer dataset.

In some embodiments, and as shown in block 504, the process flow 500 may include the step of generating a plurality of data security layer datasets with pieces of data from the user account data based on the plurality of data security layers. For instance, and in some such embodiment, the system may thus generate a of data security layer datasets with pieces of data from the user account data for each determined data security layer and for each potential recipient. Thus, and in this manner, each data security layer dataset may comprise its own, unique combination of the user account data, a copy of the user account data, and/or an imitation of the user account data. However, and in some instances where a system determines that a data security layer determined for one potential recipient matches a data security layer for another potential recipient and/or for another use-case with the same potential recipient, then the system may use the same data security layer dataset used for the other potential recipient and/or for the other use-case. In such embodiments, the system may conserve computing resources by limiting its generation of new data security layer datasets to only those data security layer datasets that have not previously been generated and comprise new combinations.

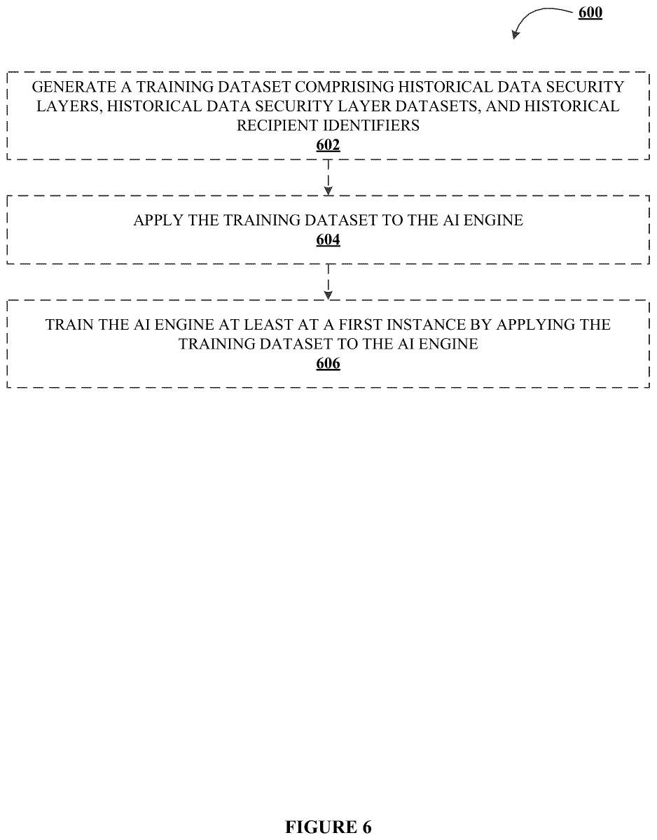

FIG. 6 illustrates a process flow 600 for training the AI engine, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process flow 600. Additionally, and in some embodiments, an AI engine (e.g., the AI subsystem 200 described herein with respect to FIG. 2) may be generated and trained to perform the steps of process flow 600.

In some embodiments, and as shown in block 602, the process flow 600 may include the step of generating a training dataset comprising historical data security layers, historical data security layer datasets, and historical recipient identifiers. For instance, and in some embodiments, the system may generate a training dataset comprising historical data security layers for a plurality of historically identified potential recipient identifiers, historical data security layer datasets generated for the plurality of data security layers, historical recipient identifiers (e.g., historical potential recipients that were identified before user account data was transmitted and/or before data security layer datasets were transmitted), and/or the like. Further, and in some embodiments, the training dataset may comprise any of the historical data described hereinabove and/or hereinbelow, which the system may collect automatically and at an initial instance and/or at an instance where the historical data is first generated or identified.

Thus, and in some embodiments, the system may generate a plurality of training datasets, each comprising data associated with each potential recipient identifier and/or each data security layer dataset generated historically up to the current instance the training dataset is generated. Thus, and as each piece of data is analyzed, determined, and generated by the AI engine, the system may feedback each piece of data (and in some embodiments a feedback from a user associated with the user account data, such as but not limited to the user indicating which pieces of user account data to add or delete from the data security layer dataset to generate an updated data security layer dataset) to retrain and refine the AI engine.

In some embodiments, and as shown in block 604, the process flow 600 may include the step of applying the training dataset to the AI engine. For instance, and in some embodiments, the system may apply the training dataset(s) to the AI engine to train the AI engine at least in a first instance. Further, and as each training dataset is generated by the system, the system may systematically and automatically apply each training dataset to the AI engine (such as once a new training dataset is generated, the system may automatically and real time or near real time apply the new training dataset to the AI engine). In some embodiments, and upon applying the training dataset(s) to the AI engine, the AI engine may process the data within the training dataset(s) to refine its determinations and combinations of user account data/data types for each future or current potential recipient and/or use-case.

In some embodiments, and as shown in block 606, the process flow 600 may include the step of training the AI engine at a first instance by applying the training dataset to the AI engine. Thus, and by applying the training dataset(s) to the AI engine, the AI engine may process and analyze each of the patterns presented in the dataset(s), generate new patterns between different pieces of data, which may in turn allow for the AI engine to be trained and configured to accurately and efficiently determine data security layers for different potential recipients, and generate data security layer datasets from different user account datasets. Such training may continue as new training datasets and feedback is generated and received, respectively. Thus, the AI engine may continually learn and refine its determinations and generation of data security layer datasets to identify the most appropriate data security layer datasets for each potential recipient, each use-case, each user, and/or the like.

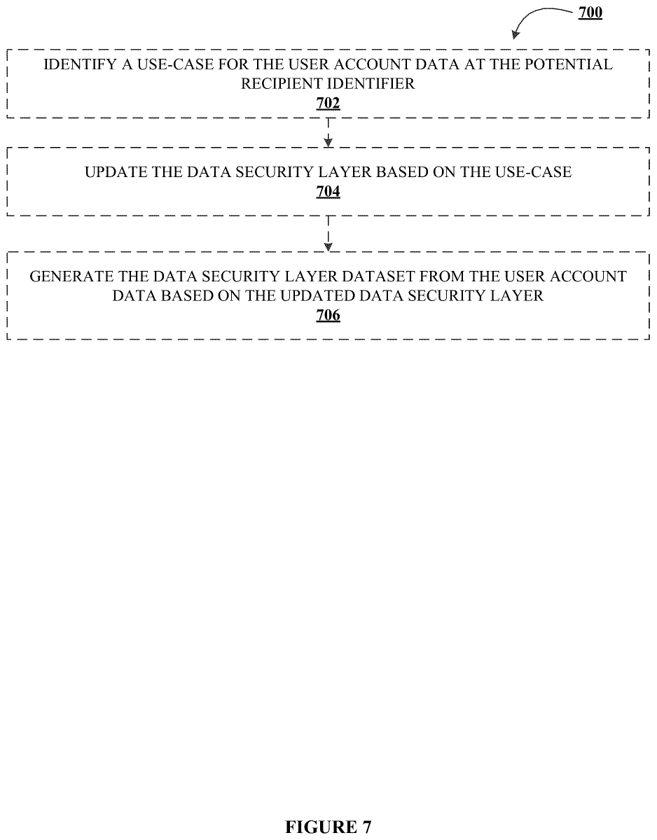

FIG. 7 illustrates a process flow 700 for generating the data security layer dataset based on an updated data security layer, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process flow 700. Additionally, and in some embodiments, an AI engine (e.g., the AI subsystem 200 described herein with respect to FIG. 2) may be generated and trained to perform the steps of process flow 700.

In some embodiments, and as shown in block 702, the process flow 700 may include the step of identifying a use-case for the user account data at the potential recipient identifier. For instance, the system may identify a use-case identify a use-case for the user account data by the potential recipient associated with the potential recipient identifier. For instance, such a use-case may comprise a sharing of the user's credit card details, home address details, phone number details, bank account information, social security number, and other such personally identifying data or non-public data stored in a user account or in a plurality of user accounts associated with a user. Thus, a use-case may refer to the underlying task the potential recipient will use the user account data for (e.g., submit a payment, submit to generate a new user account, buy commerce, submit to receive marketing materials, and/or the like), whereby the user account data may be needed to complete the requested task (which may have been requested by the user or by the potential recipient).

In some embodiments, and as shown in block 704, the process flow 700 may include the step of updating the data security layer based on the use-case. For instance, the system may update the data security layer that was previously determined in block 308 based on the identified use-case. For instance, and in such an embodiment, the AI engine may first generate its suggested data security layer based on the potential recipient identifier and the user account data alone, but upon identifying a particular use-case (which may have been done in parallel to identifying potential recipient or after identifying the potential recipient), the system may update the data security layer(s) based on the particular use-case. For instance, and where user account data associated with a user's credit card is the only data needed for the particular use-case, but the previously suggested data security layer would've allowed the potential recipient to access more than just the user's credit card information, then the system may automatically and dynamically update the data security layer to comprise the data type of a credit card or payment data.

In some embodiments, and as shown in block 706, the process flow 700 may include the step of generating the data security layer dataset from the user account data based on the updated data security layer. Thus, and based on the updated data security layer, the system may further generate the data security layer dataset based on the updated data security layer, whereby the data security layer dataset generated in this block may comprise only the credit card information for the user and/or imitation or virtual credit card data. Thus, and for instance, the step described herein with respect to block 706 may be used in lieu of the step described hereinabove with respect to block 310. However, and in some embodiments, the step provided herein may also occur after the steps provided in blocks 308-310, whereby the newly generated data security layer dataset of block 706 may actually be an updated data security layer dataset from the previously generated data security layer dataset of block 310. Thus, and in some such embodiments, the system may proactively and regularly receive updated data regarding the data security layer and/or generate new or updated data security layer datasets in real time or near real time to receiving such updated data.

Additionally, and in some such embodiments, both of the steps provided herein in updating the data security layer based on the use-case and generating the data security layer dataset in blocks 704-706 may be carried out by the AI engine described hereinabove.

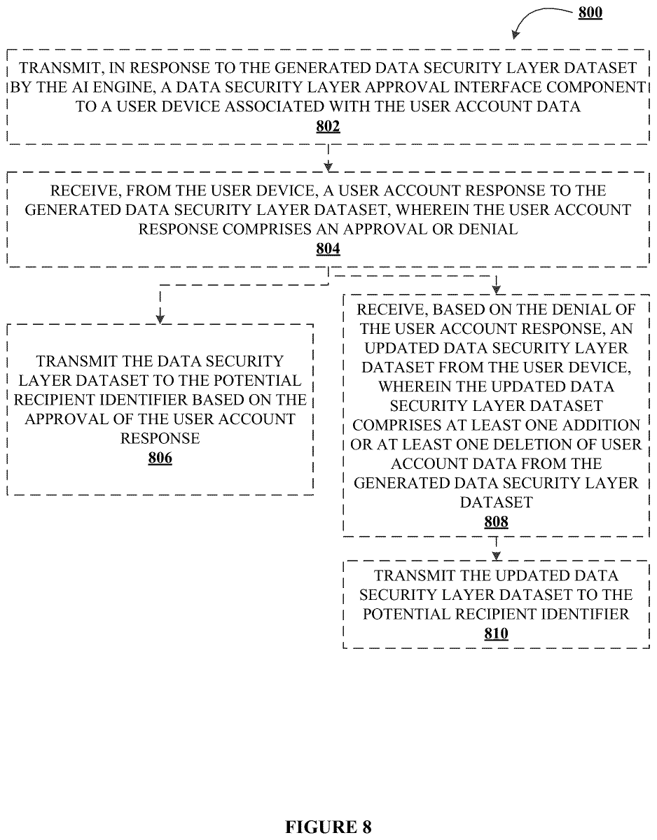

FIG. 8 illustrates a process flow 800 for receiving a user account response for the generated data security layer dataset and, in some instances, updating the generated data security layer dataset based on the user account response, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIG. 1A-1C) may perform the steps of process flow 800. Additionally, and in some embodiments, an AI engine (e.g., the AI subsystem 200 described herein with respect to FIG. 2) may be generated and trained to perform the steps of process flow 800.

In some embodiments, and as shown in block 802, the process flow 800 may include the step of transmitting, in response to the generated data security layer dataset by the AI engine, a data security layer approval interface component to a user device associated with the user account data. For instance, the system may transmit the data security layer dataset generated in block 310 to a user device within a data security layer approval interface component, whereby the data security layer approval interface component may refer to a data packet of computer-readable program code that comprises the generated data security layer dataset in computer-readable program code in a configurable manner that can be used to configure a user device's graphical user interface (GUI) upon receipt by the user device. For instance, the system may transmit the data security layer approval interface component across a network to a user device associated with the user account, and the data security layer approval interface component may configure the GUI of the user device to show the user what data is stored within the generated data security layer dataset and intended to be accessed by the potential recipient. Further, and upon the transmission of the data security layer approval interface component, the system may automatically trigger the GUI to be configured to show the data security layer approval interface component as a pop-up notification in real time or near real time.

Thus, and by configuring the GUI of the user device to show the data in the generated data security layer dataset, the system may allow for the user to manually interact with each piece of data, select one or more pieces of data with the data security layer dataset to delete or block from view by the potential recipient, and/or select additional data (such as by inputting additional data at the user device) to be stored in the data security layer dataset that the user would like to share. Therefore, the system may receive direct feedback from the user device as the user interacts with the data security layer approval interface component, and the system may direct that feedback to the AI engine for further training, while also protecting unnecessary data from a potential recipient (e.g., data that the user doesn't wish the potential recipient to see and data the system has determined the potential recipient doesn't need access to).

In some embodiments, and as shown in block 804, the process flow 800 may include the step of receiving, from the user device, a user account response to the generated data security layer dataset, wherein the user account response comprises an approval or denial. Thus, and in some such embodiments, the system may receive—from the user device via a user interacting with the user device—an approval or a denial by the user for the generated data security layer dataset, whereby the approval may indicate that the user accepts the generated data security layer dataset and its stored data to be shown and accessible to the potential recipient and a denial may indicate that the user wishes to update the data within the generated data security layer dataset (e.g., by addition, deletion, and/or the like).

In some embodiments, the user account response may comprise a user input at a keyboard associated with the user device, a “mouse” click on a clickable device associated with the user device, by a voice input by the user, and/or the like. In such embodiments, the user may indicate their acceptance or denial of the generated data security layer, and whether the user would allow or deny the potential recipient to access the current data within the generated data security layer.

In some embodiments, and as shown in block 806, the process flow 800 may include the step of transmitting the data security layer dataset to the potential recipient identifier based on the approval in the user account response. For instance, and in an embodiment where the user approves the generated data security layer dataset, the system may automatically transmit the approved data security layer dataset to the potential recipient associated with the potential recipient identifier. However, and in some embodiments, where the system has proactively generated the data security layer dataset without the user identifying a potential recipient identifier, the system may store the data security layer dataset in an approved data security layer dataset database for future transmission once the user identifies the associated potential recipient (and/or the use-case) as an intended recipient of the user account data, and in such an instance, the system may automatically and in real-time transmit the approved data security layer dataset to the potential recipient.

In some embodiments, and as shown in block 806, the process flow 800 may include the step of receiving, based on the denial of the user account response, an updated data security layer dataset from the user device, wherein the updated data security layer dataset comprises at least one addition or at least one deletion of user account data from the generated data security layer dataset. For instance, and in some embodiments, the system may receive an updated data security layer dataset from the user device, where the user may have interacted with the user device and selected (e.g., added and/or deleted data) data for the data security layer dataset. Such a process is similar to the process described hereinabove with respect to FIG. 7.

In some embodiments, and as shown in block 810, the process flow 800 may include the step of transmitting the updated data security layer dataset to the potential recipient identifier. In some such embodiments, the system may transmit, automatically in near real time or real time, the updated data security layer dataset to the potential recipient associated with the potential recipient identifier once all the updates from the user have been collected. Additionally, and in some instances where the system has proactively generated the data security layer dataset without the user identifying a potential recipient identifier, the system may store the updated data security layer dataset in an approved data security layer dataset database for future transmission once the user identifies the associated potential recipient (and/or the use-case) as an intended recipient of the user account data, and in such an instance, the system may automatically and in real-time transmit the updated data security layer dataset to the potential recipient.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating dynamic data security layers for disparate electronic environments, the system comprising:
a memory device with computer-readable program code stored thereon;
at least one processing device operatively coupled to the at least one memory device and the at least one communication device, wherein executing the computer-readable code is configured to cause the at least one processing device to:
identify a potential recipient identifier;
identify user account data associated with the potential recipient identifier;
apply the user account data and the potential recipient identifier to an artificial intelligence (AI) engine;
determine, by the AI engine, a data security layer for the potential recipient identifier and the user account data; and
automatically generate, by the AI engine, a data security layer dataset from the user account data.

2. The system of claim 1, wherein the potential recipient identifier comprises at least one of an internet protocol (IP) address, a hypertext transfer protocol secure (HTTPS) address, an electronic communication address, or a use-case identifier.

3. The system of claim 1, wherein executing the computer-readable code is further configured to cause the at least one processing device to:
generate a digital user persona based on the data security layer dataset for the user account; and
transmit the digital user persona to the potential recipient identifier.

4. The system of claim 1, wherein executing the computer-readable code is further configured to cause the at least one processing device to:
determine a plurality of data security layers based on one or more potential recipient identifiers, wherein each data security layer may be specific to each potential recipient identifier; and
generate a plurality of data security layer datasets with pieces of data from the user account data based on the plurality of data security layers.

5. The system of claim 1, wherein the potential recipient identifier is received from a user device associated with a user account of the user account data.

6. The system of claim 1, wherein executing the computer-readable code is further configured to cause the at least one processing device to:
generate a training dataset comprising historical data security layers, historical data security layer datasets, and historical recipient identifiers;
apply the training dataset to the AI engine; and
train the AI engine at least at a first instance by applying the training dataset to the AI engine.

7. The system of claim 6, wherein the training dataset comprises historical data security levels associated with a user account, historical data security layer datasets associated with the user account, and historical recipient identifiers associated with the user account.

8. The system of claim 1, wherein executing the computer-readable code is further configured to cause the at least one processing device to:
identify a use-case for the user account data at the potential recipient identifier;
update the data security layer based on the use-case; and
generate the data security layer dataset from the user account data based on the updated data security layer.

9. The system of claim 1, wherein the data security layer dataset is limited by a viability threshold time, and wherein, in an instance where the viability threshold time is met, the data security layer dataset is destroyed or denied access for the potential recipient identifier.

10. The system of claim 1, wherein executing the computer-readable code is further configured to cause the at least one processing device to:
transmit, in response to the generated data security layer dataset by the AI engine, a data security layer approval interface component to a user device associated with the user account data;
receive, from the user device, a user account response to the generated data security layer dataset, wherein the user account response comprises an approval or denial; and
transmit the data security layer dataset to the potential recipient identifier based on the approval of the user account response.

11. The system of claim 10, wherein executing the computer-readable code is further configured to cause the at least one processing device to:
receive, based on the denial of user account response, an updated data security layer dataset from the user device, wherein the updated data security layer dataset comprises at least one addition or at least one deletion of user account data from the generated data security layer dataset; and
transmit the updated data security layer dataset to the potential recipient identifier.

12. The system of claim 1, wherein the data security layer dataset is an imitation of the user account data.

13. The system of claim 1, wherein the data security layer dataset is an encrypted container or an encrypted distributed ledger entry.

14. A computer program product for generating dynamic data security layers for disparate electronic environments, wherein the computer program product comprises at least one non-transitory computer-readable medium having computer-readable program code portions embodied therein, the computer-readable program code portions which when executed by a processing device are configured to cause the processor to:
identify a potential recipient identifier;
identify user account data associated with the potential recipient identifier;
apply the user account data and the potential recipient identifier to an artificial intelligence (AI) engine;
determine, by the AI engine, a data security layer for the potential recipient identifier and the user account data; and
automatically generate, by the AI engine, a data security layer dataset from the user account data.

15. The computer program product of claim 14, wherein the computer-readable program code portions which when executed by the processing device are further configured to cause the processor to:
generate a digital user persona based on the data security layer dataset for the user account; and
transmit the digital user persona to the potential recipient identifier.

16. The computer program product of claim 14, wherein the computer-readable program code portions which when executed by the processing device are further configured to cause the processor to:
determine a plurality of data security layers based on one or more potential recipient identifiers, wherein each data security layer may be specific to each potential recipient identifier; and
generate a plurality of data security layer datasets with pieces of data from the user account data based on the plurality of data security layers.

17. The computer program product of claim 14, wherein the computer-readable program code portions which when executed by the processing device are further configured to cause the processor to:
identify a use-case for the user account data at the potential recipient identifier;
updated the data security layer based on the use-case; and
generate the data security layer dataset from the user account data based on the updated data security layer.

18. A computer implemented method for generating dynamic data security layers for disparate electronic environments, the computer implemented method comprising:
identifying a potential recipient identifier;
identifying user account data associated with the potential recipient identifier;
applying the user account data and the potential recipient identifier to an artificial intelligence (AI) engine;
determining, by the AI engine, a data security layer for the potential recipient identifier and the user account data; and
automatically generating, by the AI engine, a data security layer dataset from the user account data.

19. The computer implemented method of claim 18, further comprising:
generating a digital user persona based on the data security layer dataset for the user account; and
transmitting the digital user persona to the potential recipient identifier.

20. The computer implemented method of claim 18, further comprising:
determine a plurality of data security layers based on one or more potential recipient identifiers, wherein each data security layer may be specific to each potential recipient identifier; and
generate a plurality of data security layer datasets with pieces of data from the user account data based on the plurality of data security layers.
